(19) United States
(12) Patent Application Publication
(10) Pub. No.: US 2013/0127099 A1
(43) Pub. Date: May 23, 2013

(54) HIGH-STRENGTH SPRING

(71) Applicants: Shingo Mimura, Nagoya (JP); Takayuki Sakakibara, Nagoya (JP)

(72) Inventors: Shingo Mimura, Nagoya (JP); Takayuki Sakakibara, Nagoya (JP)

(73) Assignee: CHUO HATSUJO KABUSHIKI KAISHA, Nagoya (JP)

(21) Appl. No.: 13/813,252

(22) PCT Filed: Jun. 21, 2011
(86) PCT No.: PCT/JP2011/064165

§ 371 Date: Jan. 30, 2013

(30) Foreign Application Priority Data
Aug. 3, 2010 (JP) 2010-174772

(51) Int. Cl. F16F 1/06

(52) U.S. Cl. CPC F16F 1/06
USPC 267/166

(57) ABSTRACT

The present specification provides a spring of greater strength. A spring 2 disclosed in the present specification comprises a steel material layer 12 and a compound layer 14 containing nitride and formed on a surface of the steel material layer 12. The steel material layer 12 contains, in mass percent, C: 0.55 to 0.75, Si: 1.50 to 2.50, Mn: 0.30 to 1.00, Cr: 0.80 to 2.00, W: 0.05 to 0.30, and iron and inevitable impurities as remainders. Carbide precipitated in the steel. material layer has an average length of 0.12 μm or less and an average width of 0.04 μm or less.

### TECHNICAL FIELD

The present application relates to a high-strength spring of excellent durability (fatigue resistance) and sag resistance, and a method of producing such high-strength spring.

### BACKGROUND ART

In recent years the strength of a spring (e.g., a valve spring) used in an internal combustion engine (e.g., an automobile engine) is being requested to be enhanced in order to increase the number of revolutions of the automobile engine or to reduce the weight and the size of the same. The technology disclosed in Patent Application Publication. No. 2003-105497 is proposed as one of the measures for enhancing the strength of a spring. This technology uses a steel material that contains alloy elements such as C (carbon), Si (silicon), Mn (manganese), Cr (chromium), Mo (molybdenum), and V (vanadium), has P (phosphorous) or S (sulfur) in an amount of 0.015% or less, and has a nonmetallic inclusion in size of 15 μm or less. The steel material can be provided with desired mechanical characteristics by being subjected to a heat treatment. Next, this steel material is formed into a spring shape and thereafter subjected to a nitriding treatment.

The technology disclosed in Patent Application Publication No. 2003-166032 is known as another measure for enhancing the strength of a spring. This technology uses a steel material that contains W (tungsten) in addition to the alloy elements such as C (carbon), Si (silicon), Mn (manganese), and Cr (chromium).

### SUMMARY OF INVENTION

### Technical Problem

An object of the present application is to provide a spring of greater strength.

### Solution to Technical Problem

Based on the technology disclosed in Patent Application Publication No. 2003-105497, the inventors of the present application first attempted to produce a spring of strength greater than that of a conventional spring by adding W to the steel material disclosed in Patent. Application Publication No. 2003-105497. However, the machining process disclosed in Patent Application Publication No. 2003-105497 did not improve the strength of the spring formed from the steel material containing W. The inventors of the present application therefore had investigated various methods for improving the strength of a spring formed from a steel material containing W. As a result, the inventors have discovered that, compared to the conventional technologies, the strength of the spring had improved dramatically by defining the amount of each element such as C, Si, Mn, Cr, or W added to the steel material and controlling the size of carbide precipitated in the spring. The high-strength spring disclosed in the present specification was created based on these discoveries.

The high-strength spring disclosed in the present specification comprises a steel material layer and a compound layer formed on a surface of the steel material layer. The compound layer contains nitride. The steel material layer contains, in mass percent, C: 0.55 to 0.75, Si: 1.50 to 2.50, Mn: 0.30 to 1.00, Cr: 0.80 to 2.00, W: 0.05 to 0.30, and iron and inevitable impurities as remainders. The average length of carbide precipitated in the steel material layer is 0.12 μm or less and the average width of the same is 0.04 μm or less.

The hardness of a surface of the abovementioned spring is improved by having the compound layer containing nitride on the surface of the spring containing the components adjusted within the ranges described above. Furthermore, because the average length and the average width of the carbide precipitated in the spring are set at 0.12 μm or less and 0.04 μm or less respectively, the carbide remains finely dispersed in the spring. Therefore, the strength of the internal of the spring can be improved. As a result, the spring of the present application can be stronger than those of the conventional springs.

The steel material layer of the high-strength spring described above can further contain, in mass percent, Mo: 0.05 to 0.30 and/or V: 0.05 to 0.30. By including the Mo and/or V in the spring in the ranges described above, the carbide can easily be precipitated finely in the spring, enhancing the strength of the internal of the spring. In other words, adding one or two of these elements to the spring can improve the strength of the spring.

The thickness of the compound layer described above can be set at 5 μm or less. Setting the thickness of the compound layer at 5 μm or less can prevent a decline in the strength of the spring that is caused when the compound layer is fragile.

The high-strength spring described above can favorably be produced by, for example, the following production method. In other words, this production method comprises a step of forming a steel material into a spring shape, the steel material containing, in mass percent, C: 0.55 to 0.75, Si: 1.50 to 2.50, Mn: 0.30 to 1.00, Cr: 0.80 to 2.00, and W: 0.05 to 0.30, and a step of executing a nitriding treatment at a temperature of 450° C. or higher and 540° C. or lower after the step of forming the steel material into the spring shape.

### BRIEF DESCRIPTION OF DRAWINGS

FIG. 1 is a side view of a high-strength spring of an embodiment;

FIG. 2 is a cross-sectional diagram of a spring wire rod configuring the high-strength spring shown in FIG. 1;

FIG. 3 is a flowchart showing a procedure for producing the high-strength spring according to the present embodiment;

FIG. 4 is a diagram showing an average length of carbide contained in the high-strength spring of an example and an average length of carbide contained in a spring of a comparative example;

FIG. 5 is a diagram showing an average width of the bide contained in the high-strength spring of the example and an average width of the carbide contained in the spring of the comparative example;

FIG. 6 is a diagram showing a thickness of a compound layer contained in the high-strength spring of the example and a thickness of a compound layer contained in the spring of the comparative example;

FIG. 7 is a diagram showing the number of cycles of the high-strength spring of the example and the number of cycles of the spring of the comparative example; and

FIG. 8 is a diagram showing a compressive residual stress distribution of the high-strength spring of the example.

### DESCRIPTION OF EMBODIMENTS

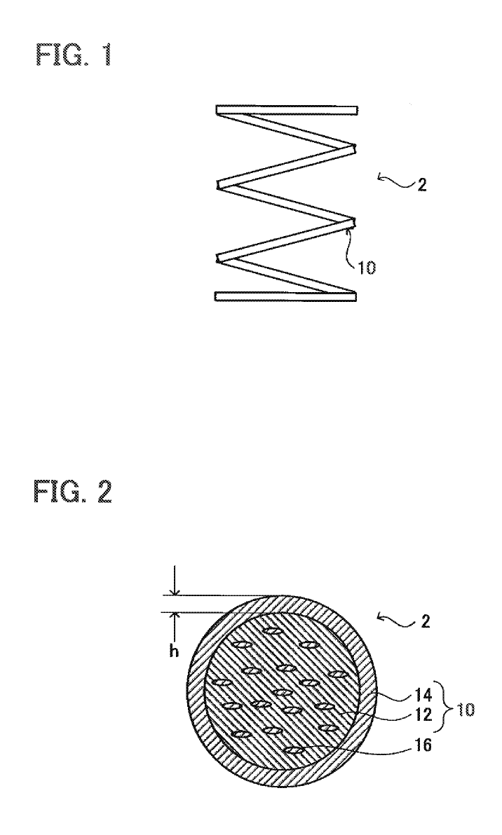

A high-strength spring 2 according to the present embodiment is used as a valve spring of an automotive engine. As shown in FIG. 1, the high-strength spring 2 is configured by a spring wire rod (steel material) 10 formed into a coil, and a predetermined interval is provided between the windings of the spring wire rod 10.

As shown in FIG. 2, the spring wire rod 10 is configured by a steel material layer 12 and a compound layer 14. The steel material layer 12 is formed by thermally treating the spring wire rod 10. The steel material layer 12 (i.e., the spring wire rod 10) contains C (carbon), Si (silicon), Mn (manganese), Cr (chromium), W (tungsten), iron, and inevitable impurities. The ratio of each of the elements is, in mass percent, C: 0.55 to 0.75%, Si: 1.50 to 2.50%, Mn: 0.30 to 1.00%, Cr: 0.80 to 2.00%, and W: 0.05 to 0.30%. The remainders are Fe (iron) and inevitable impurities.

The ratio of the C is set at 0.55% or more because C of less than 0.55% makes it difficult to satisfy both durability and sag resistance of the spring. Furthermore, the ratio of the C is set at 0.75% or less because C exceeding 0.75% lowers formability of the spring and is likely to break or damage the spring during a machining process f the spring. The ratio of the Si is set at 1.50% or more because Si of less than 1.50% cannot obtain sufficient sag resistance. The ratio of the Si is also set at 2.50% or less because Si exceeding 2.50% increases the amount of decarburization in a heat treatment beyond an acceptable range and has a negative impact on the durability. The ratio of the Mn is set at 0.30% or more because Mn of less than 0.30% cannot obtain sufficient strength. The ratio of the Mn is also set at 1.00% or lower because Mn exceeding 1.00% generates excessive retained austenite. The ratio of the Cr is set at 0.80% or more because Cr of less than 0.80% cannot achieve sufficient solution strength and hardenability. The ratio of the Cr is also set at 2.00% or less because Cr exceeding 2.00% generates excessive retained austenite. The ratio of W is set at 0.05% or more because W of less than 0.05% cannot obtain the effect of adding W (e.g., improvement of hardenability, increasing the strength of the spring). The ratio of the W is also set at 0.30% or less because W exceeding 0.30% generates coarse carbide, worsening the mechanical characteristics of the spring, such as ductility.

Carbide 16, formed by thermally treating the spring wire rod 10, is precipitated in the steel material layer 12. The carbide 16 has a spherical shape, a needle shape, or a film shape and has an average length of 0.12 μm or less and an average width of 0.04 μm or less. Setting the average length and average width of the carbide 16 at 0.12 μm or less and 0.04 μm or less respectively can keep the carbide dispersed finely in the steel material layer 12. Moreover, the carbide is present as a compound of metallic elements such as Si, Mn, Cr, W, and Fe.

The compound layer 14 is formed on the entire surface of the steel material layer 12. The compound layer 14 has a thickness h of 5 μm or less. Setting the thickness h of the compound layer 14 at 5 μm or less can prevent a decline in the strength of the spring that is caused when the compound layer is fragile. The compound layer 14 contains N (nitrogen addition to the C, Si, Mn, Cr, W, Fe, and inevitable impurities contained in the steel material layer 12, and a compound of N and the metallic elements such as Si, Mn Cr, W, and Fe (nitride) is present in the compound layer 14. The concentration of the N in the compound layer 14 is not particularly limited but is set within a range of, for example, 0.001 to 0.007% in mass percent.

According to the high-strength spring 2 described above, the use of the spring wire rod 10 containing the C, Si, Mn, Cr, and W within the abovementioned ratios can prevent the carbide precipitated in the steel material layer 12 from becoming coarse as a result of heat treatments such as annealing and a nitriding treatment. In addition, the carbide 16 precipitated in the steel material layer 12 has a spherical, needle-like, or film-like fine structure where the average length and the average width of the carbide 16 are set at 0.12 μm or less and 0.04 μm or less respectively, and the carbide 16 is finely dispersed in the steel material layer 12. Therefore, the strength and toughness of the steel material layer 12 can be improved. Furthermore, forming the compound layer 14 containing the nitride on the surface of the steel material layer 12 can not only harden the surface of the high-strength spring 2 but also keep the strength of the spring high. In addition, setting the thickness of the compound layer 14 at 5 μm or less can prevent a decline in the strength of the spring that is caused when the compound layer is fragile.

The spring wire rod 10 described above may further contain Mo (molybdenum) and/or V (vanadium). The spring wire rod 10 may contain Mo in an amount of 0.05 to 0.30 mass percent. Containing Mo can improve the strength and hardenability of the steel itself. Note that the amount of Mo is set at 0.05% or more because Mo of less than 0.05% cannot obtain the effect of adding Mo (i.e., the effect of improving the strength). The amount of Mo is also set at 0.30% or less because Mo exceeding 0.30% cannot ignore the stabilization effect of the retained austenite. The spring wire rod 10 can contain V in an amount of 0.05 to 0.30 mass percent. Containing V can generate fine carbide to be precipitated in the steel material layer 12. In other words, because the size of the carbide precipitated in the steel material layer can be made small, the strength of the steel material layer 12 can be further improved. Note that the amount of V is set at 0.05% or more because V of less than 0.05% cannot generate sufficient amount of carbide and cannot obtain the effect of preventing grain growth. The amount of V is also set at 0.30% or less because V exceeding 0.30% grows vanadium carbide itself, having a negative impact on the durability of the spring.

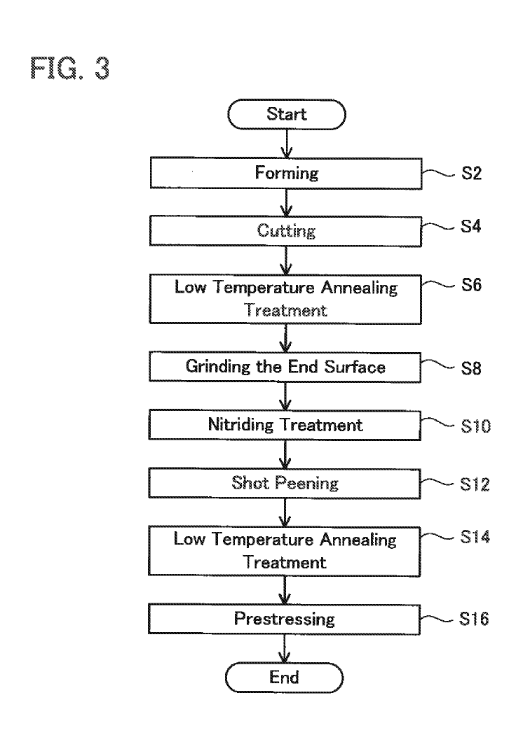

The above has described the configuration of the high-strength spring 2 according to the present embodiment. A favorable method for producing the high-strength spring 2 is described next with reference to FIG. 3.

(Method for Producing High-Strength Spring)

As shown in FIG. 3, first, the spring wire rod 10 is formed into a coil by using a coiling machine (step S2). The spring wire rod 10 contains, in mass percent, C: 0.55 to 0.75, Si: 1.50 to 2.50, Mn: 0.30 to 1.00, Cr: 0.80 to 2.00, W: 0.05 to 0.30, and iron and inevitable impurities as the remainders. Note that the spring wire rod 10 can further contain, in mass percent, Mo: 0.05 to 0.30 and/or V: 0.05 to 0.30.

Once the spring wire rod 10 is formed into a predetermined length of coil, an end part of the spring wire rod 10 is cut (step S4). Next, the spring wire rod 10 that is formed into a coil is subjected to low-temperature annealing (step S6), and an end surface of the spring wire rod 10 formed into a coil is ground (step 58). As a result, the spring wire rod 10 is formed into a spring shape.

Subsequently, the spring wire rod 10 that is formed into a spring shape is subjected to a nitriding treatment under a nitrogen gas atmosphere (step S10). As a result, the compound layer 14 containing nitride is form on a surface of the spring wire rod 10, and the steel material layer 12 without nitride is formed in a central part of the spring wire rod 10 (see FIG. 2). The nitriding treatment is executed for 1 to 4 hours at a temperature of 450° C. or higher and 540° C. or lower where the compound layer 14 to be formed on the surface of the spring wire rod 10 has a thickness of 5 μm or less and the carbide precipitated in the steel material layer 12 has an average length of 0.12 μm or less and an average width of 0.04 μm or less.

Next, a shot peening treatment is performed on the surface of the spring wire rod 10 in order to improve the durability of the spring wire rod 10 (S12). The shot peening treatment can be executed a number of times. For instance, the first shot peening is executed on the surface of the spring wire rod 10 that is obtained immediately after the nitriding treatment (shots φ: 0.6 mm), and then the second shot peening (shots φ: 0.3 mm) is executed. Thereafter, the third shot peening (shots φ: 0.1 mm) can be executed. Executing multiple stages of shot peening while changing the diameter of the shots in this manner can effectively apply compressive residual stress to the spring wire rod 10.

Once the shot peening is performed in step 512, then the spring wire rod 10 is subjected to low-temperature annealing (step S14), and prestressing is executed on the spring wire rod 10 (step S16). As a result, the high-strength spring 2 is obtained from the spring wire rod 10.

### EXAMPLES

Next are described the results obtained by measuring the average length and the average width of the carbide precipitated in the steel material layer in the high-strength spring produced with a spring wire rod containing tungsten according to the present embodiment (referred to as “present application steel material example” hereinafter) and in a high-strength spring produced with a spring wire rod that does not contain tungsten (referred to as “comparative steel material example” hereinafter).

In order to produce the high-strength spring of the present application steel material example, a spring wire rod containing, in mass percent, C: 0.55 to 0.75, Si: 1.50 to 2.50, Mn: 0.30 to 1.00, Cr: 0.80 to 2.00, W: 0.05 to 0.30, Mo: 0.05 to 0.30, V: 0.05 to 0.30, and iron and inevitable impurities as remainders, was prepared. Specifically, a spring wire rod having a composition shown in Table 1 was prepared. Furthermore, in order to produce the high-strength spring of the comparative steel material example, a spring wire rod containing, in mass percent, C: 0.55 to 0.65, Si: 1.20 to 2.50, Mn: 0.30 to 0.60, Cr: 0.40 to 2.00, Mo: 0.05 to 2.00, V: 0.05 to 0.30, and iron and inevitable impurities as remainders, was prepared. Specifically, a spring wire rod having a composition shown in Table 1 was prepared.

TABLE 1

| | C | Si | Mn | Cr | Mo | V | W | P | S |
|---|---|---|---|---|---|---|---|---|---|
| Present Application Steel | 0.61 | 2.20 | 0.55 | 1.20 | 0.12 | 0.12 | 0.15 | 0.009 | 0.002 |
| Material Example | | | | | | | | | |
| Comparative Steel Material | 0.64 | 2.02 | 0.30 | 0.88 | 0.10 | 0.10 | — | 0.010 | 0.005 |
| Example | | | | | | | | | |

The high-strength springs were produced by treating the spring wire rods having the compositions described above in accordance with the flow shown in FIG. 3. Specifications of the produced high-strength springs were as follows: wire diameter φ is 3.2 mm, mean diameter of coil φ 20.0 mm, total number of coils 6.00, number of active coils 4.00, and free length 47.0 mm. Test pieces were acquired from the produced high-strength springs, and the average length and average width of the carbide precipitated in each steel material layer, the thickness of each compound layer, and fatigue strength of each spring were measured using the test pieces. The measurement was executed on the plurality of high-strength springs with different temperature conditions for each nitriding treatment. Note that each nitriding treatment required two hours. Results of the measurement are shown in Table 2. In table 2, the durability of each spring is expressed with ◯ and x, ◯ representing target for fatigue strength (600 MPa) or more and x representing less than target for fatigue strength.

TABLE 2

| | Nitriding | | | | |
|---|---|---|---|---|---|
| | Temper- | | Thickness of | Average | Average |
| | ature | Dura- | Compound | Width | Length |
| | (° C.) | bility | layer (μm) | (μm) | (μm) |
| Present Application | 440 | x | 2.2 | 0.0231 | 0.125 |
| Steel Material | | | | | |
| Example 1 | | | | | |
| Present Application | 450 | ∘ | 3.0 | 0.0232 | 0.114 |
| Steel Material | | | | | |
| Example 2 | | | | | |
| Present Application | 460 | ∘ | 3.2 | 0.0238 | 0.0928 |
| Steel Material | | | | | |
| Example 3 | | | | | |
| Present Application | 480 | ∘ | 3.5 | 0.0236 | 0.0843 |
| Steel Material | | | | | |
| Example 4 | | | | | |
| Present Application | 500 | ∘ | 4.0 | 0.0241 | 0.0822 |
| Steel Material | | | | | |
| Example 5 | | | | | |
| Present Application | 520 | ∘ | 4.3 | 0.0232 | 0.0864 |
| Steel Material | | | | | |
| Example 6 | | | | | |
| Present Application | 540 | ∘ | 4.6 | 0.0243 | 0.0916 |
| Steel Material | | | | | |
| Example 7 | | | | | |
| Present Application | 560 | x | 5.4 | 0.0233 | 0.0952 |
| Steel Material | | | | | |
| Example 8 | | | | | |
| Comparative Steel | 380 | x | 0.1 | 0.0229 | 0.159 |
| Material Example 1 | | | | | |
| Comparative Steel | 460 | x | 1.2 | 0.0255 | 0.105 |
| Material Example 2 | | | | | |
| Comparative Steel | 500 | x | 2.6 | 0.0431 | 0.112 |
| Material Example 3 | | | | | |

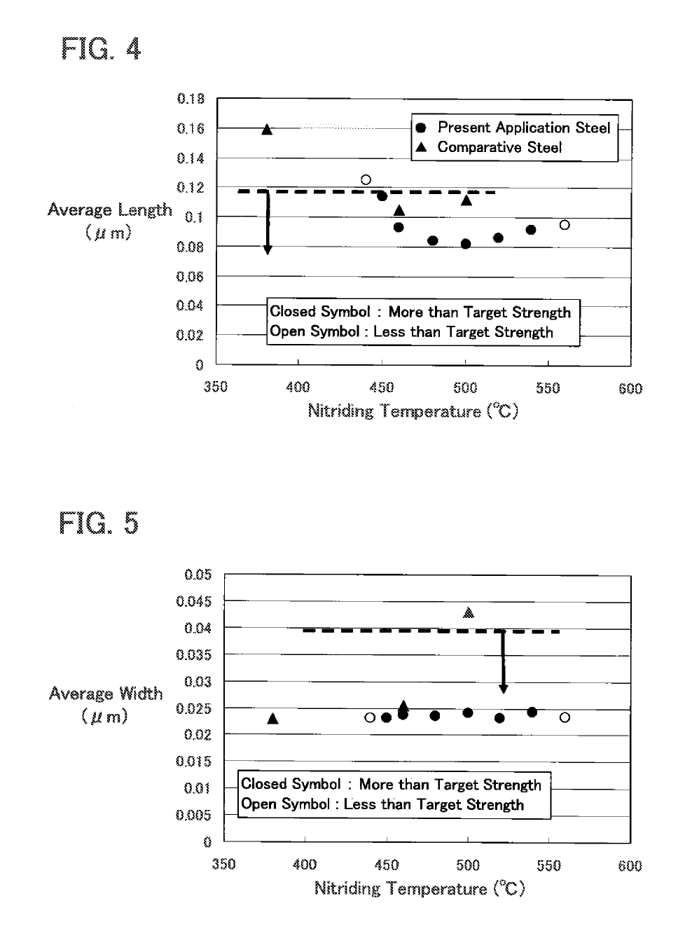

FIGS. 4 and 5 show the results obtained by measuring the average length and the average width of the carbide precipitated in each of the steel material layers of the high-strength spring of the present application steel material example and the high-strength spring of the comparative steel material example. The vertical axis of FIG. 4 represents the average length (μm) of the carbide precipitated in each steel material layer and the horizontal axis represents nitriding temperature (° C.). The vertical axis of FIG. 5 represents the average width (μm) of the carbide precipitated in each steel material layer and the horizontal axis represents nitriding temperature (° C.). In order to measure the size of the carbide, each of the test pieces subjected to the nitriding treatment was mirror-polished, slightly etched with nital to allow the carbide to surface, and thereafter subjected to imaging using a scanning electron microscope with 50,000 magnification for several fields. Next, the longitudinal length and the width perpendicular thereto of the carbide in each obtained photograph were measured. Finally, the measurement results obtained through the photographs were averaged to obtain the average length and the average width.

As shown in FIG. 4, in the high-strength spring of the present application steel material example (603 in the diagram), the average length of the carbide precipitated in the steel material layer was 0.07 μm or more and 0.12 μm or less when the nitriding temperature was 450° C. to 560° C. and exceeded 0.12 μm at a nitriding temperature of 440° C. Particularly, the high-strength spring of the present application steel material example was able to make the average length of the carbide shorter than 0.10 μm, the carbide being precipitated in the steel material layer, when the nitriding temperature was 460° C. or higher. In the high-strength spring of the comparative steel material layer example (Δ in the diagram), on the other hand, the average length of the carbide precipitated in the steel material layer did not become 0.1 μm or shorter even when the nitriding temperature was 380° C. to 500° C.

Moreover, as shown in FIG. 5, in the high-strength spring of the present application steel material example (◯ in the diagram), the average width of the carbide precipitated in the steel material layer was approximately 0.02 μm to 0.025 μm when the nitriding temperature was 440° C. to 560° C. In the high-strength spring of the comparative steel material example (Δ in the diagram), on the other hand, the average width of the carbide precipitated in the steel material layer exceeded 0.04 μm when the nitriding temperature was 500° C.

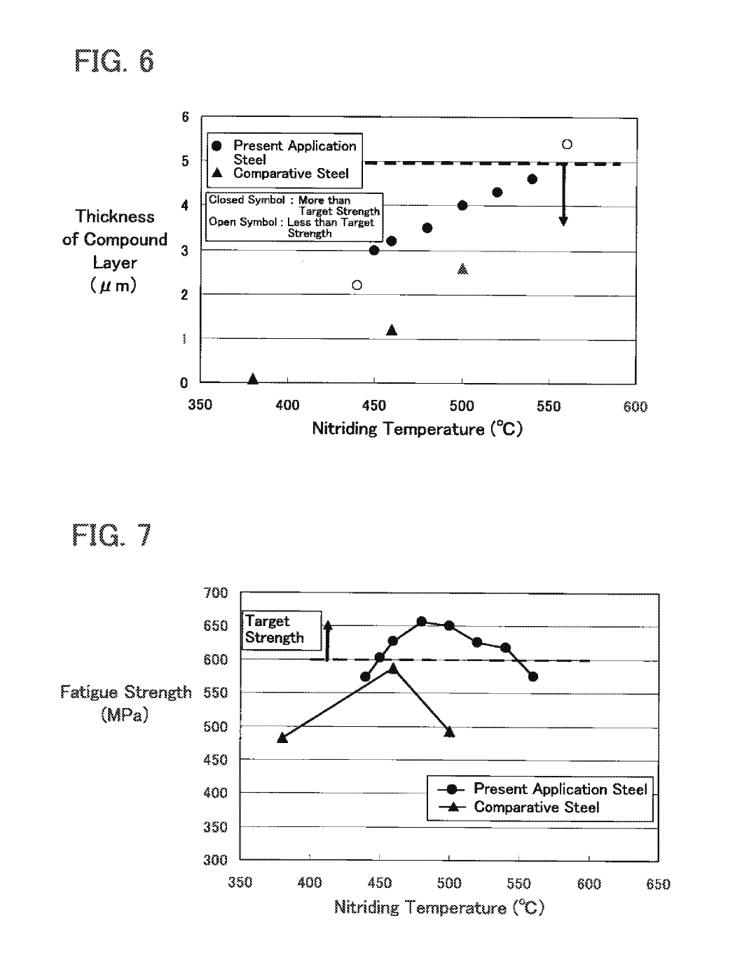

Next FIG. 6 shows the thickness of the nitride compound layer of the test piece acquired from the high-strength spring of the present application steel material example. The vertical axis represents the thickness of the compound layer (μm) from the surface of the steel material to the steel material layer, and the horizontal axis represents the nitriding temperature (° C.). After mirror-polishing the cross section of the test piece and etching the test piece with nital, the thickness of the compound layer was observed through an optical microscope with 400 magnification and measured by measuring the thickness of the nitride compound layer. As shown in FIG. 6, the thickness of the compound layer has increased with the increase in the temperature of the nitriding treatment. The thicker the compound layer, the harder the surface thereof becomes and the more fragile the compound layer becomes. Therefore, it is preferred that the thickness of the compound layer be 5 μm or less. As shown in FIG. 6, the thickness of the compound layer exceeded 5 μm when the nitriding temperature was 560° C.

As is clear from the results illustrated above, the average length and the average width of the carbide precipitated in the steel material layer was 0.12 μm or less and 0.04 μm or less respectively, by executing the nitriding treatment on the spring wire rod at a temperature of 450° C. or higher and 540° C. or lower, the spring wire rod containing, in mass percent, C: 0.55 to 0.75, Si: 1.50 to 2.50, Mn: 0.30 to 1.00, Cr: 0.80 to 2.00, and W: 0.05 to 0.30. Compared to the case where the spring wire rod of the comparative steel material example that does not contain tungsten or the spring wire rod of the present application steel material example is subjected to the nitriding treatment at a temperature of less than 450° C. or exceeding 540° C., the spring wire rod described above keeps the carbide dispersed finely in the steel material layer. In other words, compared to the other cases, the present application steel material examples 2 to 7 (i.e., the examples) can further improve the strength of the internal of the spring. In addition, setting the nitriding temperature at 540° C. or lower can obtain a nitride compound layer thickness of 5 μm or lower, preventing a decline in the strength of the spring that is caused when the compound layer is fragile.

Next, FIG. 7 shows the results obtained by measuring the durability of the high-strength spring of the present application steel material example and the durability of the high-strength spring of the comparative steel material example. When measuring the durability of the springs, a durability test was performed in which various amplitude stresses were applied to test pieces of the respective springs, with an average stress τm. of 730 MPa. Results of the durability test are shown in FIG. 7. The vertical axis of FIG. 7 represents a fatigue limit (amplitude stress (MPa)) and the horizontal axis the temperature (° C.) of a nitriding treatment. In the diagram, the high-strength spring of the present application steel material example is represented by and the high-strength spring of the comparative steel material example is represented by ▴.

As shown in FIG. 7, the test pieces according to the examples (the test pieces of the present application steel material examples 2 to 7 (except for the farthest ends)) have greater durability than the test pieces according to the comparative steel material examples 1 to 3 (▴ in the diagram). The test pieces according to the present examples (the test pieces of the present application steel material examples 2 to 7) have greater durability than the test pieces of the present application steel material examples 1, 8 and have a fatigue limit of 600 MPa or higher.

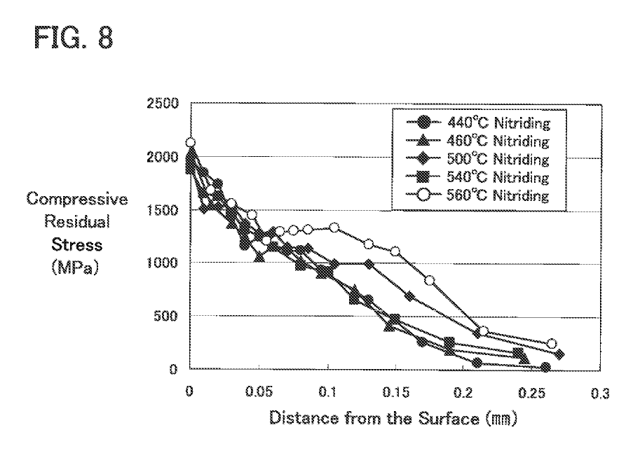

FIG. 8 shows the results obtained by measuring a compressive residual stress distribution in a depth direction from a surface of each of the test pieces obtained from the present application steel material examples 1, 3, 5, 7, 8. The vertical axis of the diagram represents the compressive residual stress (MPa) remaining in each spring wire rod and the horizontal axis represents a distance in the depth direction from the surface of each test piece at a compressive residual stress distribution measurement section. The measurement of the compressive residual stress distributions was executed on the test pieces of the present application steel material examples 1, 3, 5, 7, 8. As shown in FIG. 8, all of the test pieces had the same compressive residual stress distribution, which did not change much even when the nitriding temperature (440° C. to 560° C.) changed.

As is clear from the results illustrated above, the high-strength springs of the examples that had the spring wire rods containing tungsten and were subjected to the nitriding treatment at a temperature of 450° C. or higher and 540° C. or lower, was able to exert high fatigue strength, compared to the other high-strength springs.

While the high-strength springs of the present embodiment have been described above in detail, these examples are merely illustrative and place no limitation on the scope of the patent claims. The technology described in the patent claims also encompasses various changes and modifications to the specific examples described above. For example, the spring wire rod may contain P (phosphorous), S (sulfur), or other inevitable impurities. Because the inevitable impurities might lower the strength of the spring, it is preferred that the concentration of the inevitable impurities be low. For instance, it is preferred that the spring wire rod contain P in an amount of, in weight percent, 0.025% or lower and S in an amount of in weight percent, 0.025% or lower. Moreover, the number of times to execute the shot peening on the surface of the spring steel material can be determined in accordance with the durability required in the spring steel material. For example, preferably at least two stages of shot peening, or more preferably three stages of shot peening, is performed in order to apply a sufficient level of compressive residual stress to the spring wire rod.

The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

1. A high-strength spring, comprising:
a steel material layer; and
a compound layer containing nitride and formed on a surface of the steel material layer, wherein the steel material layer contains, in mass percent, C: 0.55 to 0.75, Si: 1.50 to 2.50, Mn: 0.30 to 1.00, Cr: 0.80 to 2.00, W: 0.05 to 0.30, and iron and inevitable impurities as remainders, and an average length of carbide precipitated in the steel material layer is 0.12 μm or less and an average width thereof is 0.04 μm or less.

2. The high-strength spring according to claim 1, wherein the steel material layer further contains, in mass percent, Mo: 0.05 to 0.30 and/or V: 0.05 to 0.30.

3. The high-strength spring according to claim 1, wherein the compound layer containing nitride has a thickness of 5 μm or less.

4. The high-strength spring according to claim 2, wherein the compound layer containing nitride has a thickness of 5 μm or less.
